(19) United States
(12) Patent Application Publication
(10) Pub. No.: US 2012/0151376 A1
(43) Pub. Date: Jun. 14, 2012

(54) FILE TRANSMISSION METHOD

(75) Inventors: CHAO-TSUNG FAN, Tu-Cheng (TW); CHUNG-JEN HSIEH, Tu-Cheng (TW)

(73) Assignee: HON HAI PRECISION INDUSTRY CO., LTD., Tu-Cheng (TW)

(21) Appl. No.: 13/209,450

(22) Filed: Aug. 15, 2011

(30) Foreign Application Priority Data
Dec. 8, 2010 (TW) 99142724

(51) Int. Cl. G06F 3/048; G06F 15/16

(52) U.S. Cl. 715/748

(57) ABSTRACT

A file transmission method detects a predetermined sending operation carried out on an icon of a selected file, which is displayed on a touch screen of a first electronic device, and detects a predetermined receiving operation on touch screen of a second electronic device. The method establishes a connection between the first electronic device and the second electronic device, and sends the selected file from the first electronic device to the second electronic device, then displays the icon of the selected device on a blank region of the touch screen of the second electronic device.

### BACKGROUND

1. Technical Field

The present disclosure relates to communication systems and methods, and more particularly, to a file transmission method.

2. Description of Related Art

At present, transferring files, such as pictures, videos, and sound files, between two portable devices, such as IPHONES and smart mobile phones, is achieved using BLUETOOTH, file transfer protocols, or emails. These file transfer modes require frequent reference to menu options, and may be boring and inconvenient to users, for example, especially older users.

### BRIEF DESCRIPTION OF THE DRAWINGS

FIG. 1 is a block diagram of one embodiment of an application environment of a file transmission method.

FIG. 2 is a flowchart of one embodiment of a file transmission method executed in a first electronic device.

FIG. 3 is a flowchart of one embodiment of a file transmission method executed in a second electronic device.

FIG. 4 illustrates an example of the transmission of a file between a first electronic device and a second electronic device.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM.

The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

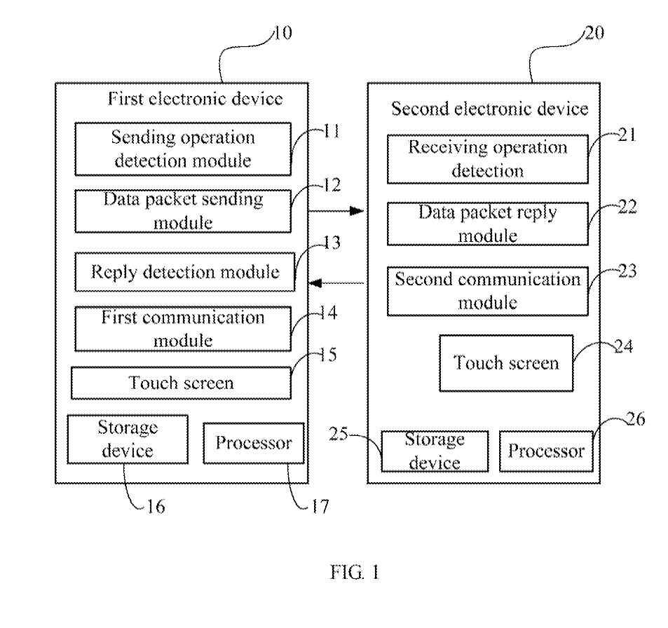

FIG. 1 is a block diagram of one embodiment of an application environment of a file transmission method. In this embodiment, the file transmission method may be executed by a first electronic device 10 and a second electronic device 20. The first electronic device 10 and the second electronic device 20 may be personal digital assistants, smart mobile phones, or any other appropriate electronic device. The file transmission method detects a predetermined file-sending operation on a touch screen 15 of the first electronic device 10 and a corresponding file-receiving operation on a touch screen 24 of the second electronic device 20, and transmits a selected file from the first electronic device 10 to the second electronic device 20 via a wireless network, such as a wireless local area network (WLAN) or a mobile device network, in response to the detected file-sending operation and file-receiving operation.

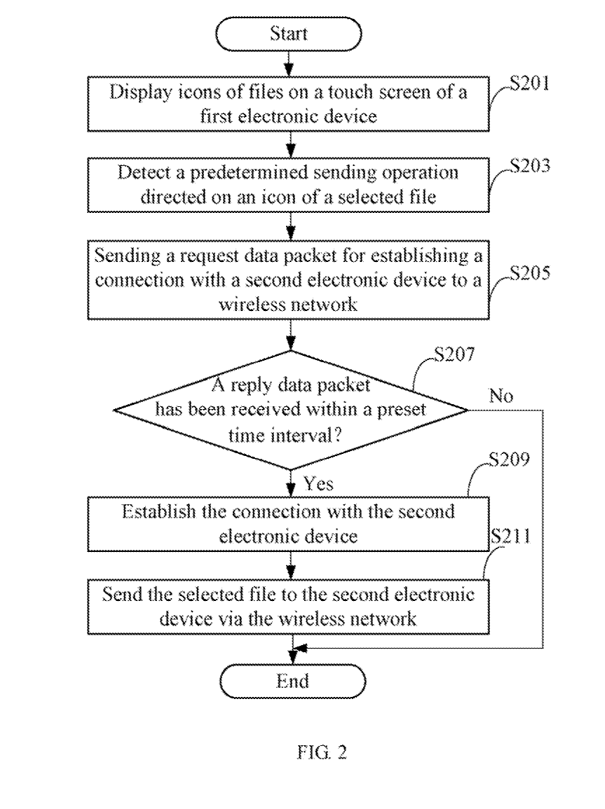

In one embodiment, the first electronic device 10 includes a plurality of function modules, such as a sending operation detection module 11, a data packet sending module 12, a reply detection module 13, and a first communication module 14. The modules 11-14 may comprise computerized code in the form of one or more programs (computer-readable program code) that are stored in a storage device 16 of the first electronic device 10. The computerized code includes instructions that are executed by a processor 17 of the first electronic device 10 to provide the below-described functions of the modules 11-14 illustrated in FIG. 2. The storage system 16 may be a cache or a memory, such as an EPROM, HDD, or flash memory.

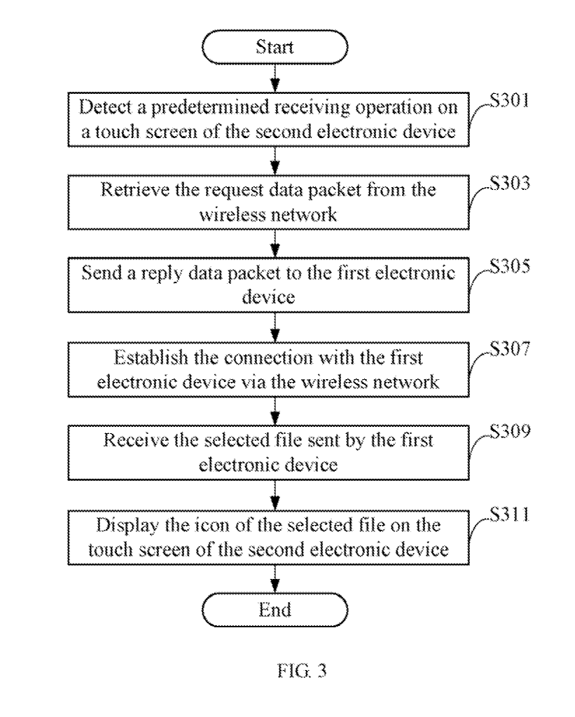

The second electronic device 20 also includes a plurality of function modules, such as a receiving operation module 21, a data packet reply module 22, and a second communication module 23. The modules 21-23 may comprise computerized code in the form of one or more programs (computer-readable program code) that are stored in a storage device 25 of the second electronic device 20. The computerized code includes instructions that are executed by a processor 26 of the second electronic device 20 to provide the below-described functions of the modules 11-14 illustrated in FIG. 3. The storage system 25 may be a cache or a memory, such as an EPROM, HDD, or flash memory.

FIG. 2 is a flowchart of one embodiment of a file transmission method executed in the first electronic device 10. Depending on the embodiment, additional blocks may be added, others removed, and the ordering of the blocks may be changed.

In block S201, the first electronic device 10 displays icons of files, such as icons representing pictures, videos, games, and sound files, on the touch screen 15 of the first electronic device 10.

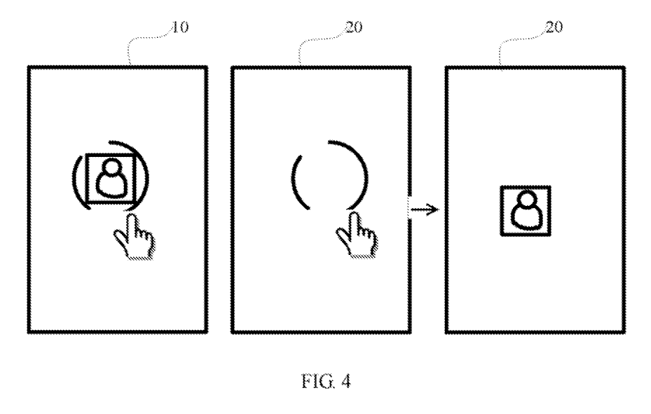

In block S203, the sending operation detection module 11 detects a predetermined sending operation on a selected file. As shown in FIG. 4, in one embodiment, the predetermined sending operation may be an operation that is detected (such as drawing a complete or incomplete circle) around the icon of a selected file (e.g., a picture). In another embodiment, the predetermined sending operation may be an operation on the icon itself or at a designated position near the icon. The operation may be from a finger (or fingers), a stylus, or a combination thereof.

In block S205, the data packet sending module 12 generates a request data packet for establishing a connection with another electronic device, and sends the request data packet to a wireless network. The request data packet includes a source port (e.g., the source port=x) specifying where the packet comes from and a destination port specifying where the packet is going.

In block S207, the reply detection module 13 detects if a reply data packet has been received within a preset time interval, such as 10 seconds. If no reply data packet has been received within the preset time interval, or if a reply data packet has been received outside the preset time interval, the first electronic device 10 cancels the sending operation, and the procedure ends. Otherwise, if a reply data packet has been received from an electronic device, such as the second electronic device 20, within the preset time interval, block S209 is implemented.

In block S209, the first communication module 14 establishes the connection between the first electronic device 10 and the second electronic device 20 via the wireless network.

In block S211, the first communication module 14 sends the selected file to the second electronic device 20 via the wireless network.

FIG. 3 is a flowchart of one embodiment of a file transmission method executed in the second electronic device 20. Depending on the embodiment, additional blocks may be added, others removed, and the ordering of the blocks may be changed.

In block S301, the receiving operation detection module 21 detects a predetermined receiving operation on the touch screen 24 of the second electronic device 20. The predetermined receiving operation may be in a designated region or a blank region of the touch screen 24. The predetermined receiving operation may be similar to the predetermined sending operation (e.g., drawing a complete or incomplete circle), or an operation preset to match the predetermined sending operation, for example, the predetermined sending operation may be defined as drawing an incomplete circle, and the matched predetermined receiving operation may be defined as drawing a complete circle.

In block S303, the second communication module 23 retrieves the request data packet from the wireless network.

In block S305, the data packet reply module 24 generates a reply data packet according to the request data packet, and sends the reply data packet to the first electronic device 10. For example, the data packet reply module 24 sets the source port (e.g., the source port=x) of the request data packet as a destination port (e.g., the destination port=x) of the reply data packet.

In block S307, the second communication module 23 establishes the connection between the first electronic device 10 and the second electronic device 20 via the wireless network.

In block S309, the second electronic device 20 receives the selected file from the first electronic device 10, and stores the selected file (now the received file) in the storage device 25.

In block S311, the second electronic device 20 displays an icon of the selected file on a blank region of the touch screen 24 (as shown in FIG. 4).

The above embodiments enable the transmission of files between electronic devices, making it as easy as picking pebbles from one place and putting them in another, and users do not need to perform multiple operations on the electronic devices.

Although certain embodiments of the present disclosure have been specifically described, the present disclosure is not to be construed as limited thereto. Various changes or modifications may be made to the present disclosure without departing from the scope and spirit of the present disclosure.

What is claimed is:

1. A computer-based file transmission method being performed by execution of computer readable program code by a processor of a first electronic device, the method comprising:
displaying icons of files on a touch screen of the first electronic device;
detecting a predetermined sending operation on the touch screen that is directed at an icon of a selected file of the first electronic device;
generating a request data packet for establishing a connection with a second electronic device, and sending the request data packet to a wireless network;
detecting if a reply data packet from the second electronic device has been received within a preset time interval; and
establishing the connection between the first electronic device and the second electronic device via the wireless network, and sending the selected file to the second electronic device on condition that the reply data packet has been received within the preset time interval.

2. The method of claim 1, further comprising:
canceling sending the selected file on condition that no reply data packet has been received, or the reply data packet has been received outside the preset time interval.

3. The method of claim 1, wherein the predetermined sending operation is an operation on the touch screen that is detected around the icon of the selected file, or an operation that is detected on the icon of the selected file, or an operation that is detected on a designated position near the icon of the selected file.

4. The method of claim 1, wherein the request data packet includes a source port of the request data packet specifying where the packet comes from and a destination port of the request data packet specifying where the packet is going.

5. The method of claim 4, wherein a destination port of the reply data packet is the same as the source port of the request data packet.

6. A computer-based file transmission method being performed by execution of computer readable program code by a processor of a second electronic device, the method comprising:
detecting a predetermined receiving operation on a touch screen of the second electronic device;
retrieving a request data packet for sending a selected file that are sent by a first electronic device from a wireless network;
generating a reply data packet according to the request data packet, and sending the reply data packet to the first electronic device;
establishing a connection between the first electronic device and the second electronic device via the wireless network;
receiving the selected file sent from the first electronic device, and storing the selected file in a storage device of the second electronic device; and
displaying an icon of the selected file in a blank region of the touch screen.

7. The method of claim 6, wherein the predetermined receiving operation is similar to a predetermined sending operation directed on the icon of the selected file that is displayed on a touch screen of the first electronic device, or an operation preset to match the predetermined sending operation.

8. The method of claim 6, wherein the request data packet includes a source port of the request data packet specifying where the packet comes from and a destination port of the request data packet specifying where the packet is going.

9. The method of claim 8, wherein a destination port of the reply data packet is the same as the source port of the request data packet.

10. A non-transitory medium storing a set of instructions, the set of instructions capable of being executed by a processor of a first electronic device to perform a file transmission method, the method comprising:
displaying icons of files on a touch screen of the first electronic device;
detecting a predetermined sending operation on the touch screen that is directed at an icon of a selected file of the first electronic device;
generating a request data packet for establishing a connection with a second electronic device, and sending the request data packet to a wireless network;
detecting if a reply data packet has been received from the second electronic device within a preset time interval; and
establishing the connection between the first electronic device and the second electronic device via the wireless network, and sending the selected file to the second electronic device on condition that the reply data packet has been received within the preset time interval.

11. The non-transitory medium of claim 10, wherein the method further comprising:
canceling sending the selected file on condition that no reply data packet has been received, or the reply data packet has been received outside the preset time interval.

12. The non-transitory medium of claim 10, wherein the predetermined sending operation on the touch screen is an operation that is detected around the icon of the selected file, or an operation that is detected on the icon of the selected file, or an operation that is detected on a designated position near the icon of the selected file.

13. The non-transitory medium of claim 10, wherein the request data packet includes a source port of the request data packet specifying where the packet comes from and a destination port of the request data packet specifying where the packet is going.

14. The non-transitory medium of claim 13, wherein a destination port of the reply data packet is the same as the source port of the request data packet.

15. A non-transitory medium storing a set of instructions, the set of instructions capable of being executed by a processor of a second electronic device to perform a file transmission method, the method comprising:
detecting a predetermined receiving operation on a touch screen of the second electronic device;
retrieving a request data packet for sending a selected file that are sent by a first electronic device from a wireless network;
generating a reply data packet according to the request data packet, and sending the reply data packet to the first electronic device;
establishing a connection between the first electronic device and the second electronic device via the wireless network;
receiving the selected file sent from the first electronic device, and storing the selected file in a storage device of the second electronic device; and
displaying an icon of the selected file on a blank region of the touch screen.

16. The non-transitory medium of claim 15, wherein the predetermined receiving operation is similar to a predetermined sending operation directed on the icon of the selected file that is displayed on a touch screen of the first electronic device, or an operation preset to match the predetermined sending operation.

17. The non-transitory medium of claim 15, wherein the request data packet includes a source port of the request data packet specifying where the packet comes from and a destination port of the request data packet specifying where the packet is going.

18. The non-transitory medium of claim 17, wherein a destination port of the reply data packet is the same as the source port of the request data packet.
